(19) United States
(12) Patent Application Publication
(10) Pub. No.: US 2026/0160678 A1
(43) Pub. Date: Jun. 11, 2026

(54) GAS ANALYSIS DEVICE, EXHAUST GAS ANALYSIS SYSTEM, AND GAS ANALYSIS METHOD

(71) Applicant: HORIBA, LTD., Kyoto-shi, Kyoto (JP)

(72) Inventors: Hiroki NISHIGAI, Kyoto-shi, Kyoto (JP); Takaaki HANADA, Kyoto-shi, Kyoto (JP); Naoki NAGURA, Kyoto-shi, Kyoto (JP)

(73) Assignee: HORIBA, LTD., Kyoto-shi, Kyoto (JP)

(21) Appl. No.: 18/705,733

(22) PCT Filed: Nov. 18, 2022
(86) PCT No.: PCT/JP2022/042840

§ 371 Date: Apr. 29, 2024

(30) Foreign Application Priority Data
Dec. 15, 2021 (JP) 2021-203648

(51) Int. Cl. G01N 21/3504

(52) U.S. Cl. CPC G01N 21/3504; G01N 2201/06113; G01N 2201/1218; G01N 2201/127

(57) ABSTRACT

The present invention is a gas analysis device that analyzes a concentration of a measurement target component contained in a sample gas, and includes a measurement cell, a gas introduction flow path through which the sample gas is introduced into the measurement cell, a gas discharge flow path through which the sample gas is discharged from the measurement cell, a pressure sensor that measures a pressure within the measurement cell, a light source that irradiates light into the measurement cell, a concentration calculation unit that, based on a light intensity of light transmitted through the measurement cell, calculates a concentration of a measurement target component contained in the sample gas, and a concentration correction unit that, based on a pressure measured by the pressure sensor, corrects the calculated concentration of the measurement target component.

### TECHNICAL FIELD

The present invention relates to a gas analysis device that analyzes, for example, exhaust gas or the like, and to an exhaust gas analysis system and a gas analysis method.

### TECHNICAL BACKGROUND

In a gas analysis device that utilizes an absorption spectroscopy method such as FTIR (Fourier Transform Infrared Spectroscopy) or QCL-IR (Mid-Infrared Laser Spectroscopy), light is irradiated into an interior of a measurement cell into which a sample gas has been introduced, and a concentration of a measurement target component present in the sample gas is analyzed based on an intensity of light transmitted through the measurement cell. In this type of gas analysis device, a quantity of infrared light absorbed by molecules within the measurement cell fluctuates depending on the pressure within the measurement cell. Because of this, it is preferable that the pressure within the measurement cell be measured, and that the concentration of the measurement target component be corrected based on the measured pressure value. For example, in Patent Document 1, the pressure of the sample gas within the measurement cell is measured by mounting a pressure sensor in the interior of the measurement cell.

### DOCUMENTS OF THE PRIOR ART

### Patent Documents

[Patent Document 1] International Patent Publication No. 2019-159581

### DISCLOSURE OF THE INVENTION

### Problems to be Solved by the Invention

However, in a case in which, as in the aforementioned Patent Document 1, a pressure sensor is provided within the measurement cell, because turbulence is easily generated within the measurement cell, and because there is an increase in the cell interior surface area, there is a decrease in responsiveness. In particular, in a case in which a highly adhesive gas such as NH₃ or the like is contained in the sample gas, this decrease in responsiveness is particularly noticeable.

In order to solve these problems, as is shown is FIG. 7, the inventors formulated the idea of measuring the pressure of a sample gas by mounting a pressure sensor on a gas discharge flow path through which a sample gas is discharged from the measurement cell. In this structure, because the pressure measurement point of the pressure sensor is separated from the measurement cell interior, a pressure loss occurs between when the sample gas exits the measurement cell and when it reaches the pressure measurement point. However, because this pressure loss is extremely small, it is considered that this method enables the pressure within the measurement cell to be measured with almost perfect accuracy.

However, as a result of further investigations by the inventors, they discovered that, in a case in which there was a difference between the flow rate of the gas introduced into the measurement cell at the time the sample gas was measured and at the time the sample gas was calibrated, this difference in the flow rate generated a difference in the extent of the pressure loss. After performing even more investigations, the inventors discovered that, even if the pressure within the measurement cell was adjusted using a regulator or the like so that there was no difference between when measurement was performed and when calibration was performed, if the pressure within the measurement cell was adjusted based on a value measured by the pressure sensor, the true pressure within the measurement cell after this adjustment was a value that was different between when measurement was performed and when calibration was performed. The inventors were consequently able to confirm that, because of this, the correction of the concentration of the measurement target component was unable to be performed correctly, and a line instruction difference was generated between when the sample gas was measured and when calibration was performed.

The present invention was conceived in view of the above-described circumstances, and it is a principal object thereof to accurately measure a pressure within a measurement cell in a gas analysis device that performs absorption spectroscopy, while maintaining a superior level of responsiveness.

### Means for Solving the Problem

Namely, a gas analysis device according to the present invention is a device that analyzes a concentration of a measurement target component contained in a sample gas, and is provided with a measurement cell, a gas introduction flow path through which the sample gas is introduced into the measurement cell, a gas discharge flow path through which the sample gas is discharged from the measurement cell, a pressure sensor that measures a pressure within the measurement cell, a light source that irradiates light into the measurement cell, a concentration calculation unit that, based on a light intensity of light transmitted through the measurement cell, calculates a concentration of a measurement target component contained in the sample gas, and a concentration correction unit that, based on a pressure measured by the pressure sensor, corrects the calculated concentration of the measurement target component, wherein the pressure sensor includes a sensor main body, and a communication pipe that connects together the sensor main body and the measurement cell, and wherein a distal end of the communication pipe is disposed in the vicinity of an introduction port of the gas introduction flow path that opens into an interior of the measurement cell or of a discharge port of the gas discharge flow path that opens into an interior of the measurement cell.

If this type of structure is employed, then because a distal end of the communication pipe of a pressure sensor is disposed in the vicinity of an introduction port of the gas introduction flow path or of a discharge port of the gas discharge flow path, it is possible to set a pressure measurement point of the pressure sensor in a position that is close to a space within the measurement cell. As a result, it is possible to reduce any effects of pressure loss and to accurately measure the pressure within the measurement cell. Consequently, it becomes possible to also reduce line instruction differences, for example, in a case in which a flow rate when measurement of a sample gas is being performed and when calibration thereof is being performed is different.

Moreover, because it is no longer necessary to provide a pressure sensor within the measurement cell, the structure of the measurement cell interior can be simplified. Because of this, it becomes difficult for turbulence to be generated within the measurement cell, and it is possible to reduce the surface area therein so that any gas adhesion thereto can be suppressed. As a result, a high level of responsiveness can be maintained.

It is preferable that a pipe body of the communication pipe that connects the sensor main body to the measurement cell be provided on an inner side of a gas introduction pipe that forms the gas introduction flow path or of a gas discharge pipe that forms the gas discharge flow path, and that this pipe body be formed having a double-pipe structure together with the gas introduction pipe or the gas discharge pipe.

If this type of structure is employed, then because the distal end of the communication pipe can be brought closer to the interior of the measurement cell, it is possible to further reduce any effects from pressure loss and to measure the pressure more accurately within the measurement cell.

Moreover, in the above-described gas analysis device, it is preferable that a gas communication port that is formed at a distal end of the communication pipe be on substantially the same plane as the introduction port of the gas introduction flow path or the discharge port of the gas discharge flow path.

If this type of structure is employed, then the gas communication port can be brought extremely close to the interior of the measurement cell, and it is possible to more accurately measure the pressure within the measurement cell. In addition, because the distal end of the communication pipe does not protrude into the interior of the measurement cell, there is no reduction in responsiveness.

If a proportion of the interior of the gas introduction pipe or the gas discharge pipe that is occupied by the communication pipe is too large, then there is a possibility that the flow of sample gas will be impeded, and that there will be a reduction in the responsiveness. Because of this, as a specific aspect of the pressure sensor, it is preferable that an outer diameter of the communication pipe be not more than half an inner diameter of the gas introduction pipe or the gas discharge pipe that is provided on an outer side thereof. Furthermore, for the same reason, it is preferable that the communication pipe is polished on its outer pipe wall.

In a case in which, as is described above, a distal end of a communication pipe of a pressure sensor is provided on a flow path of a sample gas, because turbulence is generated to a greater or lesser degree in the vicinity of this distal end, from the standpoint of inhibiting any reduction in responsiveness, it is preferable that the distal end of the communication pipe be disposed on the downstream side of the flow path.

Because of this, in the above-described gas analysis device, it is preferable that the distal end of the communication pipe be disposed in the vicinity of the discharge port of the gas discharge flow path rather than in the vicinity of the introduction port of the gas introduction flow path.

It should be noted that, in the above-described gas analysis device, a plurality of nitrogen compound components (such as NO, NO₂, N₂O, or NH₃ or the like) forms the measurement target component, and a plurality of flow paths that are used to supply span gas (i.e., span gas supply flow paths) are provided so as to correspond to each of the nitrogen compound components. In this case, if all of the plurality of span gas flow paths are consolidated and connected to a single flow path, then depending on the sequence in which span gas is supplied, there is a possibility that any residual NH₃ gas (or NO₂ gas) remaining in the flow path will intermix with NO₂ gas (or NH₃ gas) that is supplied, and will thereby generate ammonium nitrate in the flow path.

For this reason, it is preferable that a structure is employed in the above-described gas analysis device in which there is further provided a calibration gas flow path that supplies calibration gas to the measurement cell, and in which this calibration gas flow path is provided with a main calibration gas flow path that is connected to the gas introduction flow path or to the measurement cell, an NH₃ gas supply flow path that supplies NH₃ gas as a span gas to the main calibration gas flow path, and a non-NH₃ gas supply flow path that supplies non-NH₃ gas, which is a gas other than NH₃ gas, as a span gas to the main calibration gas flow path, and in which the NH₃ gas supply flow path and the non-NH₃ gas supply flow path are provided independently of each other, and merge separately from each other with the main calibration gas flow path.

If this type of structure is employed, then because the NH₃ gas supply flow path is provided independently from the non-NH₃ gas supply flow path, and these are made to merge with the main calibration gas flow path separately from each other, in a case in which NO₂ is included as one of the non-NH₃ gases, it is possible to prevent NH₃ and NO₂ from directly mixing with each other on the flow path as far as the main calibration gas flow path, so that it is possible to prevent ammonium nitrate from being generated.

An example of a specific aspect of this type of gas analysis device is a structure in which the NH₃ gas supply flow path is provided with a plurality of NH₃ gas supply flow paths, and the non-NH₃ gas supply flow path is provided with a plurality of non-NH₃ gas supply flow paths that supply at least two gases from among NO, NO₂, and N₂O as a span gas, and the gas analysis device is provided with a plurality of the NH₃ gas supply flow paths, a plurality of the non-NH₃ gas supply flow paths, an NH₃ gas consolidation flow path to which is connected a downstream end of each of the NH₃ gas supply flow paths and that consolidates the NH₃ gases supplied from each of the NH₃ gas supply flow paths, and a non-NH₃ gas consolidation flow path to which is connected a downstream end of each of the non-NH₃ gas supply flow paths and that consolidates the non-NH₃ gases supplied from each of the non-NH₃ gas supply flow paths.

Moreover, it is also preferable that a venting flow path that is used to vent residual gas remaining within each consolidation flow path be connected to the NH₃ gas consolidation flow path and the non-NH₃ gas consolidation flow path.

If this type of structure is employed, then the replacement of gas within each consolidation flow path can be accelerated.

In the automobile exhaust gas regulations, the exhaust gas is regulated by an emissions mass value. When measuring this emissions mass value, it is mainstream for a dilution measurement method to be used. In a dilution measurement method, exhaust gas emitted from an exhaust pipe of a vehicle that is serving as a test body is introduced into a dilution tunnel using an introduction pipe. The concentration of the diluted exhaust gas is then measured, or alternatively, the diluted exhaust gas is moved from the dilution tunnel to a sampling bag where the concentration of the exhaust gas inside the bag is measured. The emissions mass value is then calculated. However, in a case in which a highly adhesive component such as ammonia (NH₃) or the like contained in the exhaust gas is to be measured, when the exhaust gas is introduced into the dilution tunnel, as the exhaust gas travels to the dilution tunnel gas components become adhered to the pipe walls and the like, and it becomes difficult for an accurate emissions mass value to be calculated.

For this reason, it is preferable that an exhaust gas analysis system according to the present invention is a system that analyzes a measurement target component contained in exhaust gas that is emitted from a test body in the form of a vehicle or a portion thereof, and includes a main flow path that is connected to an exhaust pipe of the test body and into which the exhaust gas is introduced, a flow meter that measures a flow rate of the exhaust gas flowing through the main flow path, a sampling unit that collects a portion of the exhaust gas from the main flow path, the above-described gas analysis device that analyzes the exhaust gas collected by the sampling unit and measures a concentration of the measurement target component, and an emissions quantity calculation unit that, based on a flow rate of the exhaust gas measured by the flow meter, and on the concentration of the measurement target component measured by the gas analysis device, calculates a quantity of emissions from the measurement target component.

In addition, a gas analysis method of the present invention is characterized in that a concentration of a measurement target component contained in a sample gas is analyzed using the above-described gas analysis device.

According to this type of gas analysis method, the same type of action and effects as those obtained from the above-described gas analysis device of the present invention can be demonstrated.

Moreover, an example of an aspect that clearly demonstrates an effect of the present invention is a mode in which a flow rate of the sample gas introduced into the measurement cell at a time when an analysis is being performed is greater than a flow rate of a calibration gas introduced into the measurement cell at a time when a calibration is being performed.

### Effects of the Invention

According to the present invention that is formed in the manner described above, in a gas analysis device that performs absorption spectroscopy, it is possible to accurately measure a pressure within a measurement cell while maintaining a superior level of responsiveness.

### BRIEF DESCRIPTION OF THE DRAWINGS

FIG. 1 is an overall schematic view of a gas analysis device according to an embodiment of the present invention.

FIG. 2 is a cross-sectional view schematically showing a structure of a multiple reflection cell of the same embodiment.

FIG. 3 is an overall schematic view of an exhaust gas analysis system that is provided with the gas analysis device of the same embodiment.

FIG. 4 is a cross-sectional view schematically showing a structure of a multiple reflection cell of another embodiment.

FIG. 5 is a cross-sectional view schematically showing a structure of a multiple reflection cell of another embodiment.

FIG. 6 is a view schematically showing a structure of a calibration gas flow path in another embodiment.

FIG. 7 is an overall schematic view of an exhaust gas analysis system according to another embodiment.

FIG. 8 is a cross-sectional view schematically showing a structure of a conventional multiple reflection cell.

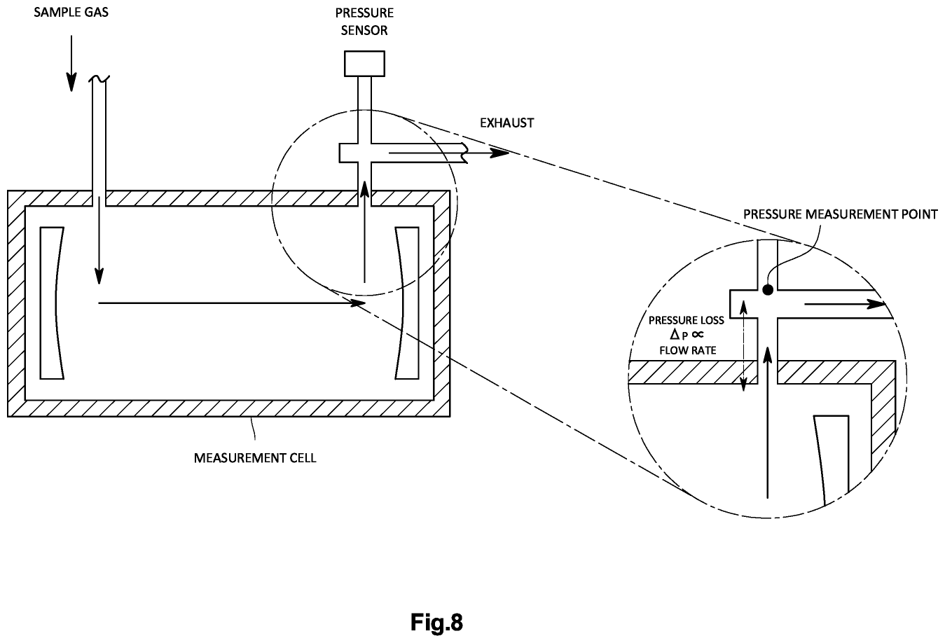

### BEST EMBODIMENTS FOR IMPLEMENTING THE INVENTION

Hereinafter, an embodiment of a gas analysis device 100 according to the present invention, as well as an exhaust gas analysis system 200 in which this gas analysis device 100 is provided will be described with reference to the drawings.

### (1) Gas Analysis Device

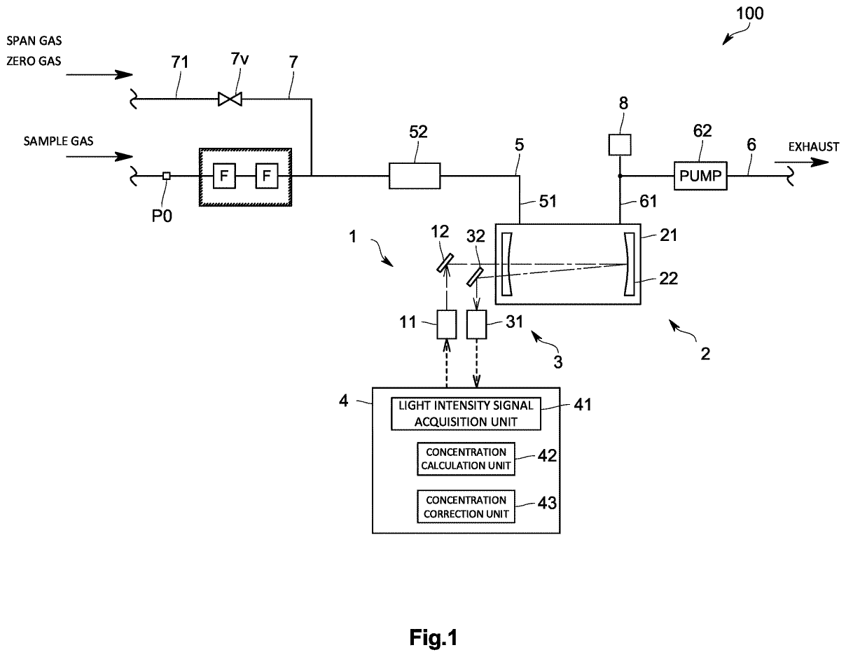

Firstly, the gas analysis device 100 of the present embodiment will be described. The analysis device of the present embodiment is an exhaust gas analysis device 100 that measures a concentration of one or more components contained in exhaust gas that is emitted, for example, from an internal combustion engine of an automobile or the like. More specifically, as is shown in FIG. 1, this gas analysis device 100 is formed in such a way that it collects either a portion of, or all of exhaust gas that is emitted, for example, from a tail pipe of a vehicle using a sample collection unit PO, and then introduces the exhaust gas (which may be referred to below as ‘sample gas’) collected by this sample collection unit PO into a multiple reflection-type measurement cell 2. The gas analysis device 100 then measures the concentration of one or more measurement target components present in the exhaust gas (for example, a nitrogen compound component such as NO, NO₂, N₂O, or NH₃) using absorption spectroscopy.

More specifically, this gas analysis device 100 is provided with a light irradiation unit 1, a measurement cell 2 into which a sample gas is introduced and that causes light from the light irradiation unit 1 to be reflected multiple times, a photodetection unit 3 that detects light emitted from the measurement cell 2, and an information processing device 4 that analyzes a measurement target component contained in the sample gas based on a light intensity signal detected by the photodetection unit 3.

The light irradiation unit 1 is provided with one or more laser light sources 11 that emit laser light, and a guide mechanism 12 such as a reflective mirror or the like that guides the light from the laser light source 11 to the measurement cell 2. The laser light source 11 is a variable wavelength laser that emits laser light having an infrared region wavelength such as in a mid-infrared region or a near infrared region, or an oscillation wavelength in an ultraviolet region, and employing, for example, a quantum cascade laser (QCL), a semiconductor laser such as a variable wavelength semiconductor laser or the like, a solid-state laser, or a liquid laser as the laser light source 11 may be considered.

It is particularly preferable that a quantum cascade laser (QCL) be used as the laser light source 11. In absorption spectrophotometry that utilizes a QCL as the light source (i.e., QCL-IR), an element that has been adjusted so that light in a wave number range in which an absorption peak of a target component is present is oscillated is used.

The measurement cell 2 is a type of cell known as a Herriott cell. This measurement cell 2 is equipped with a cell main body 21 into an internal space S of which a sample gas is introduced, and a pair of reflective mirrors 22 that are provided facing each other inside the cell main body 21.

The photodetection unit 3 is provided with one, or a plurality of photodetectors 31 that detect a light intensity of irradiated light after this light has been reflected multiple times within the measurement cell 2. The photodetector 31 may be formed by a thermal type of detector such as, for example, a comparatively low-cost thermopile or the like or, alternatively, quantum photoelectric elements such as HgCdTe, InGaAs, InAsSb, or PbSe devices or the like which have high responsiveness may also be used. Note that a guide mechanism 32 such as a reflective mirror or the like that is used to guide the light emitted from the measurement cell 2 to the photodetector 31 is provided between the measurement cell 2 and the photodetector 31. A light intensity signal obtained by the photodetector 31 is output to the information processing device 4.

The information processing device 4 is equipped with analog electrical circuits formed by buffers and amplifiers and the like, digital electrical circuits formed by a CPU and memory and the like, and an AD converter and DA converter or the like that interfaces between these analog and digital electrical circuits. As a result of the CPU and peripheral devices thereof operating in mutual collaboration in accordance with a predetermined program stored in a predetermined area of the memory, the information processing device 4 performs at least the functions of a light intensity signal acquisition unit 41 that acquires the light intensity signal output from the photodetector 31, a concentration calculation unit 42 that performs arithmetic processing on the acquired light intensity signal so as to calculate a concentration of each measurement target component, and a concentration correction unit 43 that corrects the calculated concentration of a measurement target component in accordance with a pressure within the measurement cell 2 measured by a pressure sensor 8 (described below). Note that the information processing device 4 may also perform a function of a display unit that displays the concentration and the like of a measurement target component.

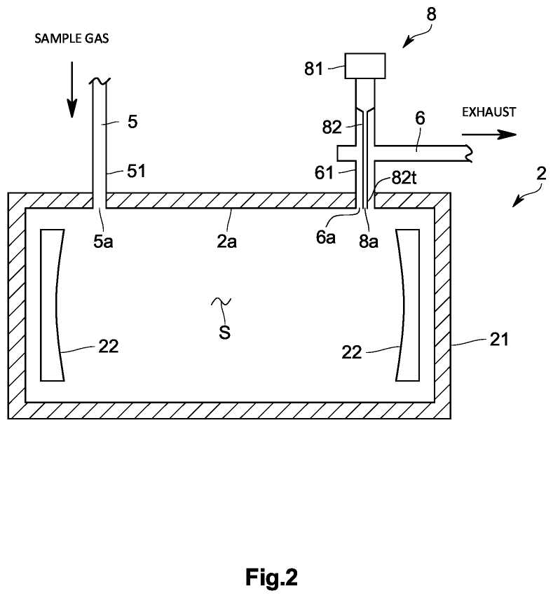

As is shown in FIG. 1 and FIG. 2, the gas analysis device 100 is also provided with a gas introduction flow path 5 through which a collected sample gas is introduced into the measurement cell 2, and a gas discharge flow path 6 through which an analyzed sample gas is discharged from the measurement cell 2.

An upstream end of the gas introduction flow path 5 is connected to the sample collection unit PO, while a downstream end thereof is connected to the measurement cell 2. More specifically, a gas introduction port 5a that is formed at a downstream end of a gas introduction pipe 51 forming the gas introduction flow path 5 opens in an inner wall 2a of the measurement cell 2, and the sample gas is introduced into the measurement cell 2 interior through this gas introduction port 5a. Either one or a plurality of filters F that are used to remove dust contained in the collected sample gas, and a flow rate limiting portion 52 that is used to limit a flow rate of the sample gas that has passed through this upstream-side filter F are provided in this sequence from the upstream side on the gas introduction flow path 5. The upstream-side filter F is heated by a heating mechanism so as to reach a predetermined temperature (for example 113° C.). The flow rate limiting portion 52 used here is either an orifice (FO) or a needle valve, and a downstream side thereof has a reduced pressure compared to an upstream side thereof. In addition, a heating pipe that is used to prevent adhesion or condensation of adhesive gases such as NH₃ or the like contained in the sample gas is provided on the gas introduction flow path 5 between the upstream-side filter F and the flow rate limiting portion 52.

An upstream end of the gas discharge flow path 6 is connected to the measurement cell 2. More specifically, a discharge port 6a that is formed at an upstream end of a gas discharge pipe 61 forming the gas introduction flow path 6 opens in the inner wall 2a of the measurement cell 2, and the analyzed sample gas is taken in through this discharge port 6a and is then discharged onto the downstream side. A pump 62 that is used to introduce the sample gas into the measurement cell 2 is provided on the gas discharge flow path 6. This pump 62 places the interior of the measurement cell 2 in a state of negative pressure, and also places the flow path portion of the gas introduction flow path 5 from the downstream side of the flow rate limiting portion 52 to the measurement cell 2, as well as the flow path portion of the gas discharge flow path 6 from the measurement cell 2 to the pump 62 in a state of negative pressure (for example, approximately 25 kPa).

In addition, the gas analysis device 100 is provided with a calibration gas flow path 7 that supplies a calibration gas such as a zero gas or span gas or the like that is used to perform calibration (i.e., zero calibration or span calibration) to the measurement cell 2. A main on/off valve 7v that opens or closes the flow path is provided on the calibration gas flow path 7.

This calibration gas flow path 7 supplies, as a zero gas, a gas (for example, N₂ or the like) that does not contain any of the measurement target component, and that has no effect on the spectrum in the vicinity of the measurement target component. In addition, this calibration gas supply path 7 supplies, as a span gas, a gas that contains a predetermined concentration of a measurement target component. Here, a description is given of a case in which the measurement target component is at least one of NH₃, NO, NO₂, and N₂O.

The gas analysis device 100 is additionally provided with a pressure sensor 8 that is located externally of the measurement cell 2, and is used to measure the pressure of the sample gas within the measurement cell 2. This pressure sensor 8 is, for example, a capacitance-type diaphragm vacuum gauge, and is provided with a sensor main body 81 that includes a sensing portion such as a diaphragm or the like that is deformed as a result of receiving pressure from a sample gas, and a communicating pipe 82 that connects together the sensor main body 81 and the measurement cell 2. The communicating pipe 82 is formed, for example, in a rectilinear shape having one end portion thereof connected to the sensor main body 81, and a communicating port 8a formed at a distal end 82t, which is another end portion thereof. The pressure sensor 8 is disposed in such a way that the communicating port 8a of the communicating pipe 82 is located on the flow path along which the sample gas flows.

In this way, in the gas analysis device 100 of the present embodiment, as is shown in FIG. 2, the sensor 8 is installed in such a way that the gas communicating port 8a thereof is located in the vicinity of the discharge port 6a of the gas discharge flow path 6.

More specifically, in the present embodiment, the communication pipe 82 (more specifically, the pipe body forming the communication pipe 82) of the pressure sensor 8 is formed having a double pipe structure together with the gas discharge pipe 61 in which either a portion of or all of the communication pipe 82 is disposed on the inner side of the gas discharge pipe 61 of the gas discharge flow path 6. The communication pipe 82, which is serving as the inner pipe, is disposed on the inner side of the gas discharge pipe 61, which is serving as the outer pipe, and the sample gas is discharged onto the downstream side through a toroidal flow path that is formed between the outer pipe wall of the communication pipe 82 and the inner pipe wall of the gas discharge pipe 61.

The pipe body forming the communication pipe 82 is formed in a narrow tube shape, and it is preferable that an outer diameter thereof is not more than half an inner diameter of the gas discharge pipe 61. If this type of structure is employed, then by reducing the proportion of the interior of the gas discharge pipe 61 that is occupied by the communication pipe 82, it is possible to facilitate the flow of sample gas and further improve responsiveness.

It is also preferable for the gas discharge pipe 61 and the communication pipe 82 to be formed coaxially with each other in the vicinity of the discharge port 6a, and for the openings of the gas communication port 8a and the discharge port 6a to face in the same direction. If this type of structure is employed, then it is possible to further improve the responsiveness to pressure fluctuations in the sample gas.

Moreover, it is also preferable that a distance between end portions of the gas communication port 8a and the discharge port 6a (in other words, a distance between an end portion of the discharge port 6a of the gas discharge pipe 61 and an end portion of the gas communication port 8a) be not more than a length of an aperture diameter of the discharge port 6a, and it is preferable that this distance be set to not more than 10 mm, or more preferably, to not more than 5 mm. It is also preferable that the openings of the gas communication port 8a and the discharge port 6a are set so as to be substantially on the same plane as each other along the inner wall 2a of the measurement cell 2. If this type of structure is employed, then the gas communication port 8a can be brought extremely close to the inside of the measurement cell 2, and the pressure within the measurement cell 2 can be measured more accurately. Note that the gas communication port 8a may protrude into the internal space S side beyond the inner wall 2a of the measurement cell 2, or conversely may be withdrawn back onto the gas discharge pipe 61 side.

According to the gas analysis device 100 of the present embodiment that is formed in this manner, by installing the distal end 82t of the communication pipe 82 of the pressure sensor 8 in the vicinity of the discharge port 6a of the gas discharge flow path 6, it is possible to set the pressure measurement point of the pressure sensor 8 to a position that is close to the internal space S of the measurement cell 2. Because of this, the effects of pressure loss can be reduced, and it becomes possible to accurately measure the pressure within the measurement cell 2. As a consequence, it is possible to also reduce a line instruction difference, for example, in a case in which the flow rate of a sample gas during measurement and the flow rate thereof during calibration and the like are mutually different. Moreover, because the pressure sensor 8 is disposed outside the measurement cell 2, the structure within the measurement cell 2 can be simplified. Because of this, it becomes difficult for turbulence to be generated within the measurement cell 2. Moreover, because the surface area is also smaller so that gas adhesion can be suppressed, a high level of responsiveness can be maintained.

### (2) Exhaust Gas Analysis System

Next, an example of the exhaust gas analysis system 200 that employs the gas analysis device 100 of the present embodiment will be described.

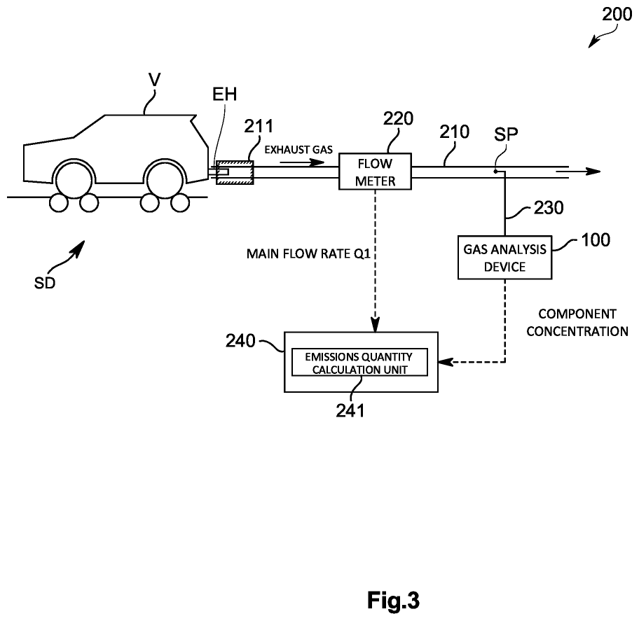

This exhaust gas analysis system 200 analyzes exhaust gas emitted from a test vehicle that is serving as a test body, and measures an emissions quantity of a measurement target component contained in the exhaust gas. As is shown in FIG. 3, this exhaust gas analysis system 200 is provided with a chassis dynamometer SD on which is mounted a test vehicle V, a main flow path 210 that is connected to an exhaust pipe EH of the test vehicle V and into which is introduced exhaust gas (i.e., undiluted raw exhaust gas) emitted from an engine, a flow meter 220 that measures a flow rate of exhaust gas flowing through the main flow path 210, a sampling unit 230 that collects a portion of the exhaust gas from the main flow path 210, the above-described gas analysis device 100 that measures a concentration of a measurement target component by analyzing the exhaust gas collected by the sampling unit 230, and a control device 240 that functions as an emissions quantity calculation unit 241 that calculates an emissions quantity of the measurement target component.

The flow meter 220 is, for example, an ultrasonic wave flow meter, however, the present invention is not limited to this, and another type of flow meter such as a pitot tube flow meter or the like. The sampling unit 230 is formed so as to collect exhaust gas from a sampling point SP that is set on the downstream side of the flow meter 220 on the main flow path 210.

The emissions quantity calculation unit 241 is formed so as to calculate a quantity of measurement target component emissions based on a flow rate (Q1) of the exhaust gas measured by the flow meter 220, and on the concentration of the measurement target component measured by the gas analysis device 100. More specifically, the emissions quantity calculation unit 241 calculates an emissions mass of a measurement target component by multiplying a flow rate (Q1) of the exhaust gas acquired from the flow meter 220 on the main flow path 210 by the concentration of the measurement target component acquired from the gas analysis device 100.

According to the exhaust gas analysis system 200 of the present embodiment that is formed in this manner, because it is possible to accurately measure the pressure within the measurement cell 2 while maintaining a high level of responsiveness via the gas analysis device 100, it becomes possible to accurately measure the concentration of a measurement target component, and to also accurately measure the emissions mass of the measurement target component.

### (3) Additional Embodiments

Note that the gas analysis device 100 and the exhaust gas analysis system 200 of the present invention are not limited to those described in the above embodiment.

For example, in the above-described embodiment, the pressure sensor 8 is installed in such a way that the communication port 8a thereof is located in the vicinity of the discharge port 6a of the gas discharge flow path 6, however, the present invention is not limited to this. In another embodiment, the pressure sensor 8 may be installed in such a way that the gas communication port 8a thereof is located in the vicinity of the introduction port 5a of the gas introduction flow path 5. In this way as well, the gas communication port 8a can be brought closer to the inside of the measurement cell 2 so that the pressure within the measurement cell 2 can be measured more accurately. In this case, it is preferable that a distance between end portions of the gas communication port 8a and the introduction port 5a (in other words, a distance between an end portion of the introduction port 5a of the gas introduction pipe 51 and an end portion of the gas communication port 8a) be not more than a length of an aperture diameter of the introduction port 5a, and it is preferable that this distance be set, for example, to not more than 10 mm, or more preferably, to not more than 5 mm. It is also preferable that the openings of the gas communication port 8a and the introduction port 5a are set so as to be substantially on the same plane as each other along the inner wall 2a of the measurement cell 2. Note that the gas communication port 8a may protrude into the internal space S side beyond the inner wall 2a of the measurement cell 2, or conversely may be withdrawn back onto the gas introduction pipe 51 side.

Moreover, in another embodiment, it is not essential that the gas discharge pipe 61 and the communication pipe 82 be formed concentrically with each other, and neither is it essential that the openings of the discharge port 6a and the gas communication port 8a be formed on the same plane as each other. In addition, it is not necessary that the pipe body forming the communication pipe 82 be formed in a narrow tube shape, nor is it necessary that the outer diameter thereof be no more than half the inner diameter of the gas discharge pipe 61.

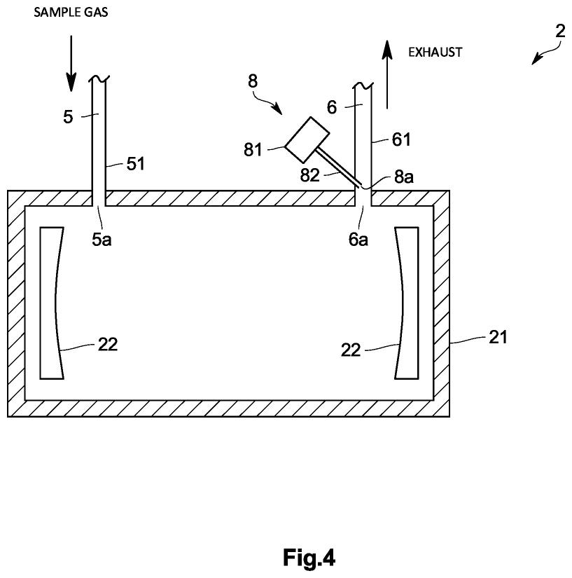

Furthermore, in another embodiment, it is not necessary that the communication pipe 82 of the pressure sensor 8 be formed having a double pipe structure together with the gas discharge pipe 61. For example, in a gas analysis device 100 of another embodiment, as is shown in FIG. 4, it is also possible for the pressure sensor 8 to be disposed in such a way that the distal end portion of the communication pipe 82 penetrates a pipe wall of the gas discharge pipe 61 so that the gas communication port 8a is positioned in the vicinity of the discharge port 6a (preferably, so that the distance thereof from the discharge port 6a is not more than half the length of the aperture diameter of the discharge port 6a, for example, not more than 10 mm, and more preferably not more than 5 mm). In this case as well, because it is possible to set the pressure measurement point of the pressure sensor 8 at a position that is close to the internal space S of the measurement cell 2, it is possible to reduce the effects of pressure loss, and to accurately measure the pressure within the measurement cell 2.

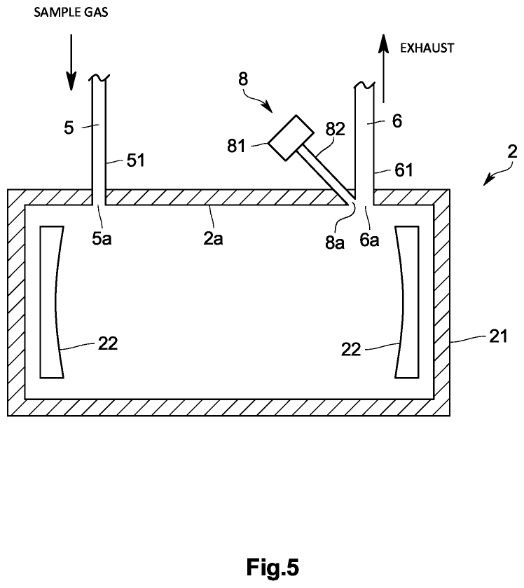

Moreover, in the gas analysis device 100 of another embodiment, as is shown in FIG. 5, it is possible for the pressure sensor 8 to be disposed in such a way that the communication pipe 82 penetrates the side wall 2a of the measurement cell 2 so that the gas communication port 8a thereof that is formed in the side wall 2a is positioned in the vicinity of the discharge port 6a (preferably, so that the distance thereof from the discharge port 6a is not more than half the length of the aperture diameter of the discharge port 6a, for example, not more than 10 mm, and more preferably not more than 5 mm) that is also formed in the side wall 2a. In this case, as is shown in FIG. 5, it is possible for the gas communication port 8a and the discharge port 6a to form a continuous, common aperture in the side wall 2a. In this case as well, because it is possible to set the pressure measurement point of the pressure sensor 8 at a position that is close to the internal space S of the measurement cell 2, it is possible to reduce the effects of pressure loss, and to accurately measure the pressure within the measurement cell 2.

In the above-described embodiment, the gas analysis device 100 is a gas analysis device that employs the principle of spectroscopic analysis such as an FTIR method, a QCL-IR method, or an NDIR method. Moreover, it is not essential that the measurement cell 2 be a multiple reflection-type cell, and neither is it essential that the measurement cell 2 be a Herriott cell. Instead of these, a white cell, for example, may be used.

In addition, in the above-described embodiment, the light irradiation unit 1 is provided with the laser light source 11 as a light source, however, the present invention is not limited to this. In another embodiment, the light irradiation unit 1 may be provided with a light-emitting diode (LED), or with a halogen lamp or the like as a light source.

Furthermore, in addition to the measurement target components described above, the gas analysis device 100 of another embodiment may also be formed in such a way that it can also measure a concentration in a case in which a hydrocarbon such as CH4 or the like, a sulfur compound such as SO₂ or the like, CO, CO₂, H₂O, an alcohol, or an aldehyde or the like is used as the measurement target component.

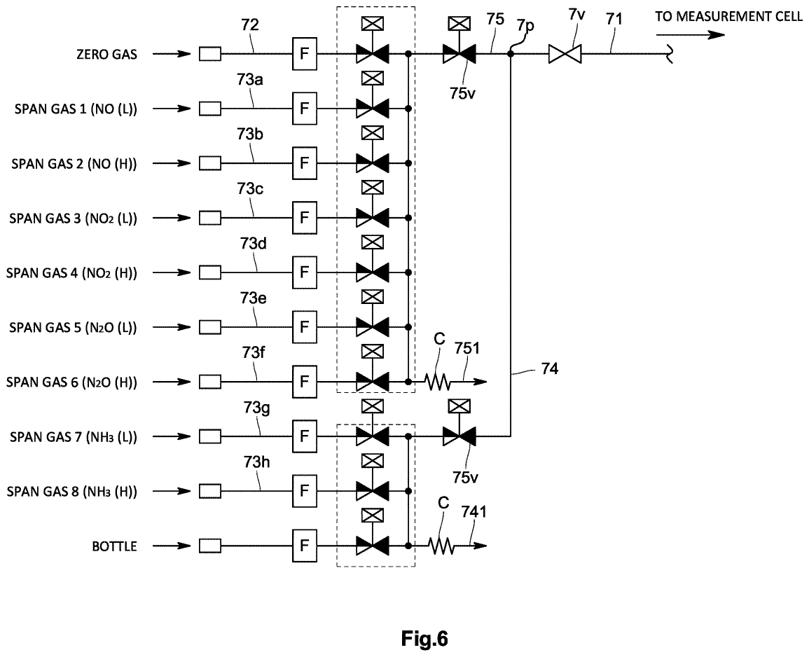

The calibration gas flow path 7 of the gas analysis device 100 of another embodiment will now be described with reference to FIG. 6.

As is shown in FIG. 6, the calibration gas flow path 7 of another embodiment is provided with a main calibration gas flow path 71 whose downstream end is connected to the gas introduction flow path 5 or the measurement cell 2, a zero gas supply flow path 72 that supplies zero gas to the main calibration gas flow path 71, and a span gas supply flow path 73 that supplies span gas to the main calibration gas flow path 71.

In this embodiment, the calibration gas flow path 7 may be formed so as to supply a plurality of types of span gas (here, low concentration NO gas, high concentration NO gas, low concentration NO₂ gas, high concentration NO₂ gas, low concentration N₂O gas, high concentration N₂O gas, low concentration NH₃ gas, or high concentration NH₃ gas,) so as to correspond to a plurality of measurement target components. In addition, as is shown in FIG. 6, the calibration gas flow path 7 of this embodiment may also be provided with a plurality of span gas supply flow paths 73 so as to correspond to each of the aforementioned span gases. More specifically, the calibration gas flow path 7 may be provided with a plurality of span gas supply flow paths (these may also be referred to as non-NH₃ gas supply flow paths) 73a˜73f that supply a gas other than NH₃ (this may also be referred to as a non-NH₃ gas) as a span gas, and with a plurality of span gas supply flow paths (these may also be referred to as NH₃ gas supply flow paths) 73g, 73h that supply NH₃ gas as a span gas. The zero gas supply flow path 72 and the plurality of span gas supply flow paths 73a˜73h may be set in a mutually parallel relationship relative to the main calibration gas flow path 71. Note that upstream ends of the zero gas supply flow path 72 and of the respective span gas supply flow paths 73a˜73f may be connected to gas sources such as a corresponding gas cylinder or the like. Note also that an on/off valve that opens or closes the flow path and a filter may be disposed on the zero gas supply flow path 72 and the respective span gas supply flow paths 73a˜73f.

In addition, in the calibration gas flow path 7 of this embodiment, the plurality of NH₃ gas supply flow paths 73g, 73h and the plurality of non-NH₃ gas supply flow paths 73a˜73f are provided so as to be mutually independent of each other, and they may also be provided such that each one merges separately with the main calibration gas flow path 71.

More specifically, the calibration gas flow path 7 of this embodiment may be provided with an NH₃ gas consolidation flow path 74 to which downstream ends of the respective NH₃ gas supply flow paths 73g and 73h are connected, and that consolidates the NH₃ gases supplied from the respective NH₃ gas supply flow paths 73g and 73h, and a non-NH₃ gas consolidation flow path 75 to which downstream ends of the respective non-NH₃ gas supply flow paths 73a˜73f are connected, and that consolidates the non-NH₃ gases supplied from the respective non-NH₃ gas supply flow paths 73a˜73f. The NH₃ gas consolidation flow path 74 and the non-NH₃ gas consolidation flow path 75 are provided so as to be mutually independent of each other, and may be set in a mutually parallel relationship relative to the main calibration gas flow path 71. Moreover, the downstream ends of the NH₃ gas consolidation flow path 74 and the non-NH₃ gas consolidation flow path 75 may be connected to a merge point 7p that is set upstream from the main on/off valve 7v on the main calibration gas flow path 71. It is also possible for on/off valves 74v and 75v that open or close the relevant flow path to be provided respectively on each of the consolidation flow paths 74 and 75.

It is also possible for venting flow paths 741 and 751 that vent any residual gas remaining in the relevant flow path to be connected respectively to the NH₃ gas consolidation flow path 74 and the non-NH₃ gas consolidation flow path 75 on the upstream side thereof from the on/off valves 74v and 75v. A pressure loss mechanism C such as a capillary or an orifice or the like may be provided respectively on each of the venting flow paths 741 and 751. Moreover, the non-NH₃ gas consolidation flow path 75 of this embodiment may also be formed in such a way that the downstream end of the zero gas supply flow path 72 is connected thereto, so that zero gas such as N₂ gas flowing through the zero gas supply flow path 72 is consolidated together with the non-NH₃ gas.

In this way, by providing the plurality of NH₃ gas supply flow paths 73g and 73h, and the plurality of non-NH₃ gas supply flow paths 73a˜73f in such a way that these two flow path groups are mutually independent of each other, it is possible to prevent NH₃ and NO₂ from directly mixing together in the consolidation flow paths 74 and 75 as far as the main calibration gas flow path 71, so that it is possible to prevent ammonium nitrate from being created.

Moreover, as yet a further embodiment, it is not necessary that a plurality of both the non-NH₃ gas supply flow paths and the NH₃ gas supply flow paths be provided on the calibration gas flow path 7, and it is also possible for a single flow path to be provided for either one of or for both of these flow path groups. In this case as well, by providing the NH₃ gas supply flow path and the non-NH₃ gas supply flow path such that they are mutually independent of each other, and such that they merge separately from each other with the main calibration gas flow path 71, it is possible to prevent NH₃ and NO₂ from directly mixing together as far as the main calibration gas flow path 71, so that it is possible to prevent ammonium nitrate from being created.

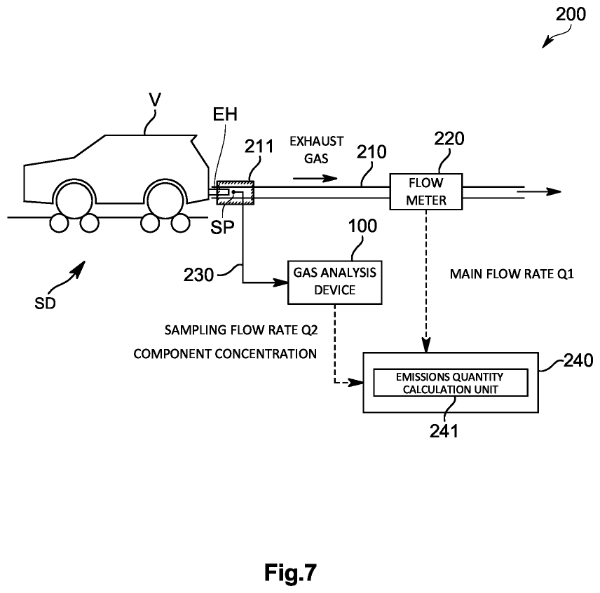

An exhaust gas analysis system 200 of another embodiment will now be described using FIG. 7.

As is shown in FIG. 7, the exhaust gas analysis system 200 of another embodiment may be formed in such a way that the sampling unit 230 collects a portion of the exhaust gas from directly underneath the exhaust pipe EH on the upstream side from the flow meter 220 on the main flow path 210.

More specifically, the flow meter 220 of this embodiment may be formed so as to measure the flow rate (also referred to as the main flow rate) of the exhaust gas flowing in the main flow path 210 on the downstream side from the sample point SP of the sampling unit 230. In other words, the exhaust gas flow rate that is measured by this flow meter 220 can be said to be a flow rate obtained by subtracting the flow rate of the exhaust gas collected by the sampling unit 230 from the total flow rate of the exhaust gas introduced from the exhaust pipe EH of the test vehicle V into the main flow path 210.

A structure may also be employed in which the sampling unit 230 collects exhaust gas from directly beneath the exhaust pipe EH (i.e., immediately behind the exit port thereof) on the main flow path 210. In order to prevent adhesion or condensation of adhesive gases such as NH₃ or the like, it is also possible for a portion of the main flow path 210 between the exit port of the exhaust pipe EH and the sample point SP to be temperature-controlled via heating from a heating mechanism 211, or for the temperature thereof to be maintained using thermal insulation or the like. If this type of structure is employed, then it is possible to reduce the adhesion of gas to the pipe inner wall between the exit port of the exhaust pipe EH and the sample point SP, and to calculate the emissions quantity of the measurement target component more accurately. Moreover, it is also possible for polishing processing to be performed on the pipe inner surfaces of the temperature-controlled segment of the main flow path 210 in order to prevent the adhesion thereto of adhesive gases.

In this exhaust gas analysis system 200, it is also possible to employ a structure in which the emissions quantity calculation unit 241 calculates the emissions quantity of the measurement target component based on a corrected flow rate obtained by correcting the main flow rate measured by the flow meter 220 using a sampling flow rate which is the flow rate collected by the sampling unit 230, and on the concentration of the measurement target component measured by the gas analysis device 100. More specifically, it is also possible for the emissions quantity calculation unit 241 to acquire a main flow rate (Q1) on the main flow path 210 measured by the flow meter 220, and a sampling flow rate (Q2) measured by a flow meter (not shown in the drawings) provided in the gas analysis device 100, and to then calculate a corrected flow rate (Q3) by adding these together. The emissions mass of the component being measured may then be calculated by multiplying the concentration of the measurement target component acquired from the gas analysis device 100 by the corrected flow rate. Note that an introduction flow rate or the like that has been set in advance in the gas analysis device 100 may be used as the sampling flow rate (Q2).

According to the exhaust gas analysis system 200 of another embodiment that is formed in the manner described above, because a structure is employed in which exhaust gas is sampled immediately after it has been emitted from the exhaust pipe EH on the upstream side from the flow meter 220, it is possible to accurately measure the concentration of a highly adhesive measurement target component in a state in which there is little adhesion thereof to the pipe internal walls. Moreover, because the flow rate measured by the flow meter 220 is corrected using a sample exhaust gas flow rate, it is possible to suppress any effects therefrom on the flow rate values used to calculate an emissions quantity while the exhaust gas from the upstream side of the flow meter 220 is being sampled. As a result, it is possible to suppress any effects from a measurement target component adhering to a pipe internal wall, and to thereby accurately measure an emissions quantity.

In each of the above-described embodiments, the exhaust gas analysis system 200 measures a measurement target component present in exhaust gas emitted during a test performed using a chassis dynamometer, however, the present invention is not limited to this. In another embodiment, it is also possible for a measurement target component present in exhaust gas emitted during a test performed using a drive test apparatus such as an engine testing apparatus or a power train or the like to be measured. Moreover, the exhaust gas analysis system 200 may also be an on-board type of system that is mounted in the test vehicle V.

In each of the above-described embodiments, the gas analysis device 100 and the exhaust gas analysis system 200 analyze a measurement target component present in exhaust gas that has been emitted from an internal combustion engine such as a vehicle engine or the like, however, the present invention is not limited to this. In another embodiment, it is also possible to measure a measurement target component present, for example, in an external combustion engine such as a thermal power plant or the like, or in air flue exhaust gas emitted from a factory or the like. Moreover, the gas analysis device 100 is not limited to exhaust gas and may also be used to analyze other types of gases, for example, to analyze gases emitted from secondary cells such as storage batteries, or from fuel cells or the like.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

### INDUSTRIAL APPLICABILITY

According to the above-described present invention, in a gas analysis device that performs absorption spectrophotometry, it is possible to accurately measure a pressure within a measurement cell while maintaining a high level of responsiveness.

### DESCRIPTION OF THE REFERENCE NUMERALS

100 . . . Gas Analysis Device
1 . . . Light Irradiation Unit
2 . . . Measurement Cell
5 . . . Gas Introduction Flow Path
5a . . . Introduction Port
6 . . . Gas Discharge Flow Path
6a . . . Discharge Port
8 . . . Pressure Sensor
81 . . . Sensor Main Body
82 . . . Communication Pipe
8a . . . Communication Port

1. A gas analysis device that analyzes a concentration of a measurement target component contained in a sample gas, comprising:
a measurement cell;
a gas introduction flow path through which the sample gas is introduced into the measurement cell;
a gas discharge flow path through which the sample gas is discharged from the measurement cell;
a pressure sensor that measures a pressure within the measurement cell;
a light source that irradiates light into the measurement cell;
a concentration calculation unit that, based on a light intensity of light transmitted through the measurement cell, calculates a concentration of a measurement target component contained in the sample gas; and
a concentration correction unit that, based on a pressure measured by the pressure sensor, corrects the calculated concentration of the measurement target component, wherein
the pressure sensor includes a sensor main body, and a communication pipe that connects together the sensor main body and the measurement cell, and
a distal end of the communication pipe is disposed in the vicinity of an introduction port of the gas introduction flow path that opens into an interior of the measurement cell or of a discharge port of the gas discharge flow path that opens into an interior of the measurement cell.

2. The gas analysis device according to claim 1, wherein a pipe body of the communication pipe that connects the sensor main body to the measurement cell is provided on an inner side of a gas introduction pipe that forms the gas introduction flow path or of a gas discharge pipe that forms the gas discharge flow path, and is formed having a double-pipe structure together with the gas introduction pipe or the gas discharge pipe.

3. The gas analysis device according to claim 2, wherein a communication port that is formed at a distal end of the communication pipe is on substantially the same plane as the introduction port of the gas introduction flow path or the discharge port of the gas discharge flow path.

4. The gas analysis device according to claim 2, wherein an outer diameter of the communication pipe is not more than half an inner diameter of the gas introduction pipe or the gas discharge pipe that is provided on an outer side thereof.

5. The gas analysis device according to claim 2, wherein the communication pipe is polished on its outer pipe wall.

6. The gas analysis device according to claim 1, wherein the distal end of the communication pipe is disposed in the vicinity of the discharge port of the gas discharge flow path.

7. The gas analysis device according to claim 1, further comprising a calibration gas flow path that supplies calibration gas to the measurement cell, wherein this calibration gas flow path comprises:
a main calibration gas flow path that is connected to the gas introduction flow path or to the measurement cell;
an NH3 gas supply flow path that supplies NH3 gas as a span gas to the main calibration gas flow path; and
a non-NH3 gas supply flow path that supplies non-NH3 gas, which is a gas other than NH3 gas, as a span gas to the main calibration gas flow path, and wherein
the NH3 gas supply flow path and the non-NH3 gas supply flow path are provided independently of each other, and merge separately from each other with the main calibration gas flow path.

8. The gas analysis device according to claim 7 wherein the NH3 gas supply flow path comprises a plurality of NH3 gas supply flow paths, and
the non-NH3 gas supply flow path comprises a plurality of non-NH3 gas supply flow paths that supply at least two gases from among NO, NO2, and N2O as a span gas, and wherein
the gas analysis device further comprises:
an NH3 gas consolidation flow path to which is connected a downstream end of each of the NH3 gas supply flow paths and that consolidates the NH3 gases supplied from each of the NH3 gas supply flow paths; and
a non-NH3 gas consolidation flow path to which is connected a downstream end of each of the non-NH3 gas supply flow paths and that consolidates the non-NH3 gases supplied from each of the non-NH3 gas supply flow paths.

9. The gas analysis device according to claim 7, wherein a venting flow path that is used to vent residual gas remaining within each consolidation flow path is connected to each of the NH3 gas consolidation flow path and the non-NH3 gas consolidation flow path.

10. An exhaust gas analysis system that analyzes a measurement target component contained in exhaust gas that is emitted from a test body in the form of a vehicle or a portion thereof, comprising:
a main flow path that is connected to an exhaust pipe of the test body and into which the exhaust gas is introduced;
a flow meter that measures a flow rate of the exhaust gas flowing through the main flow path;
a sampling unit that collects a portion of the exhaust gas from the main flow path;
the gas analysis device according to claim 1 that analyzes the exhaust gas collected by the sampling unit and measures a concentration of the measurement target component; and
an emissions quantity calculation unit that, based on a flow rate of the exhaust gas measured by the flow meter, and on the concentration of the measurement target component measured by the gas analysis device, calculates a quantity of emissions from the measurement target component.

11. A gas analysis method in which a concentration of a measurement target component contained in a sample gas is analyzed using the gas analysis device according to claim 1.

12. The gas analysis method according to claim 11, wherein a flow rate of the sample gas introduced into the measurement cell at a time when an analysis is being performed is greater than a flow rate of a calibration gas introduced into the measurement cell at a time when a calibration is being performed.
